(19) United States
(12) Patent Application Publication
(10) Pub. No.: US 2006/0134479 A1
(43) Pub. Date: Jun. 22, 2006

(54) Controlling a fuel cell system

(76) Inventors: Luhui Hu, San Diego, CA (US); Tonya M. Sutphin, Clifton Park, NY (US)

Correspondence Address: TROP PRUNER & HU, PC, 8554 KATY FREEWAY, SUITE 100, HOUSTON, TX, 77024, US

(21) Appl. No.: 11/022,340

(22) Filed: Dec. 22, 2004

(51) Int. Cl. H01M 8/04

(52) U.S. Cl. 429/22; 429/13

(57) ABSTRACT

A technique includes providing a network in communication with components of a fuel cell system. The technique includes identifying at least one node of a fuel cell system and automatically configuring the fuel cell system based on at least one characteristic of the identified node(s).

### BACKGROUND

The invention generally relates to controlling a fuel cell system.

A fuel cell is an electrochemical device that converts chemical energy produced by a reaction directly into electrical energy. For example, one type of fuel cell includes a polymer electrolyte membrane (PEM), often called a proton exchange membrane, that permits only protons to pass between an anode and a cathode of the fuel cell. At the anode, diatomic hydrogen (a fuel) is reacted to produce hydrogen protons that pass through the PEM. The electrons produced by this reaction travel through circuitry that is external to the fuel cell to form an electrical current. At the cathode, oxygen is reduced and reacts with the hydrogen protons to form water. The anodic and cathodic reactions are described by the following equations:
H₂→2H⁺+2e⁻ at the anode of the cell, and Equation 1
O₂+4H⁺+4e⁻→2H₂O at the cathode of the cell. Equation 2

A typical fuel cell has a terminal voltage near one volt DC. For purposes of producing much larger voltages, several fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one fuel cell of the stack. The plates may include various surface flow channels and orifices to, as examples, route the reactants and products through the fuel cell stack. Several PEMs (each one being associated with a particular fuel cell) may be dispersed throughout the stack between the anodes and cathodes of the different fuel cells. Electrically conductive gas diffusion layers (GDLs) may be located on each side of each PEM to form the anode and cathodes of each fuel cell. In this manner, reactant gases from each side of the PEM may leave the flow channels and diffuse through the GDLs to reach the PEM.

The fuel cell stack is one out of many components of a typical fuel cell system, as the fuel cell system includes various subsystems, such as a cooling subsystem, a monitoring subsystem, a control subsystem, a power conditioning subsystem, etc. for purposes of controlling operation of the fuel cell stack and controlling the delivery of power from the stack to a load. The particular design of each of these subsystems is a function of the application that the fuel cell system serves.

For example, the fuel cell system may provide power to an AC power-consuming load, such as a residential load. Thus, the power conditioning subsystem of the fuel cell system includes such components as an inverter to form an AC voltage that appears at the output terminals of the system. The design of the inverter as well as the design of other components of the fuel cell system depends on the level of power that is provided by the system. For example, the components of the fuel cell system may have one design for a 5 kilowatt (kW) system and another design for a 10 kW system. As another example, the fuel cell system may provide power for a DC load instead of an AC load. The power conditioning system for this DC-type fuel cell system does not include an inverter; and similar to the AC system, the design of the power conditioning subsystem depends on the level of power output.

Thus, the specific design and specific components of a fuel cell system depends on the particular application in which the system is used. This is also true for the control subsystem, the subsystem that monitors and controls the operations of the fuel cell system. Therefore, for each fuel cell system design, the control subsystem is specifically designed for the specific components of the design. For example, program instructions that control operation of the control subsystem are written specifically in view of the design to inform the control subsystem about the identity and configuration of the various components of the fuel cell system. However, specifically designing the control subsystem for each different fuel cell system configuration may significantly affect the manufacturing costs and time.

Therefore, there is a continuing need for a system and/or technique to address one or more of the problems that are stated above, as well as possibly address one or more problems that are not set forth above.

### SUMMARY

In an embodiment of the invention, a technique includes providing a network in communication with components of a fuel cell system and identifying at least one node of the network. The technique includes automatically configuring the fuel cell system based on at least one characteristic of the identified node(s).

Advantages and other features of the invention will become apparent from the following drawing, description and claims.

### BRIEF DESCRIPTION OF THE DRAWING

FIG. 1 is a schematic diagram depicting a network of a fuel cell system according to an embodiment of the invention.

FIG. 2 is a flow diagram depicting a technique to configure a fuel cell system according to an embodiment of the invention.

FIG. 3 is a message flow diagram depicting communication between a master node and slave nodes of the network according to an embodiment of the invention.

FIGS. 4 and 5 are flow diagrams depicting techniques to detect failure of a node of the network according to embodiments of the invention.

FIG. 6 is a message flow diagram depicting an event-driven communication between a data provider and a data consumer over the network according to an embodiment of the invention.

FIG. 7 is a schematic diagram depicting a transmit and receive architecture according to an embodiment of the invention.

FIG. 8 is a flow diagram depicting a technique to retrieve received packet data from a receive FIFO according to an embodiment of the invention.

FIG. 9 is a flow diagram depicting a technique to transfer received packet data from a receiver buffer to a receive FIFO according to an embodiment of the invention.

FIG. 10 is a flow diagram depicting a technique to furnish packet data to be transmitted into a transmit FIFO according to an embodiment of the invention.

FIG. 11 is a flow diagram depicting a technique to transfer packet data to be transmitted from a FIFO to a transmit buffer according to an embodiment of the invention.

FIG. 12 is a block diagram of a fuel cell system according to an embodiment of the invention.

### DETAILED DESCRIPTION

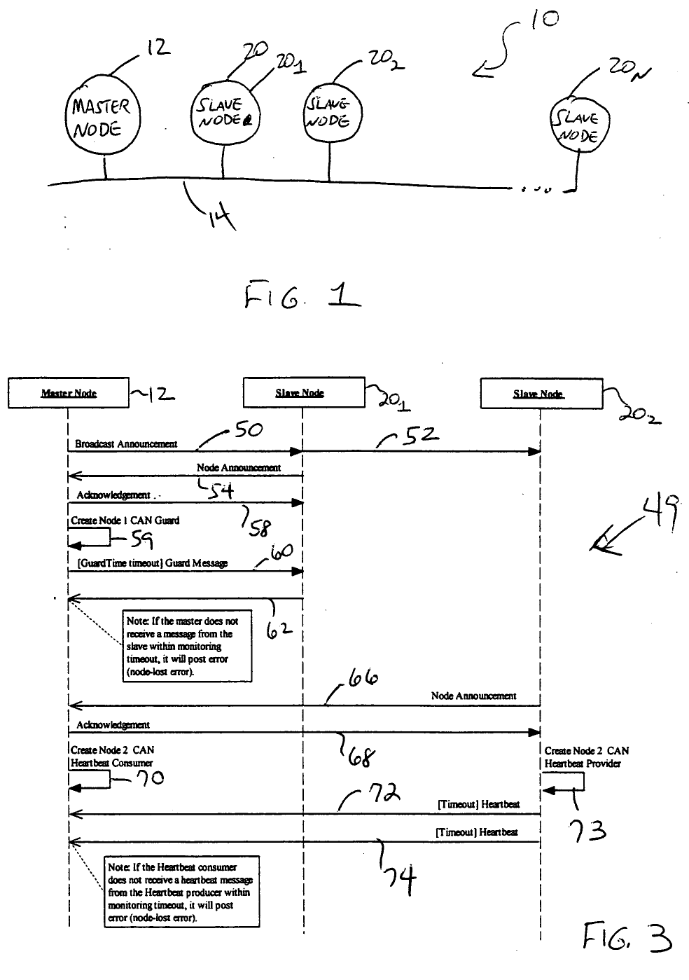

In accordance with an embodiment of the invention, a fuel cell system includes various electrical components, such as a system controller; an AC-to-DC inverter; a DC-to-DC converter; sensors (a hydrogen sensor, a carbon monoxide sensor, a temperature sensor, current sensor, etc.); actuators (a valve actuator, for example); motors (a fan motor, for example); heaters; relay switches; etc. All of these electrical components collectively serve to control operation of a fuel cell stack of the fuel cell system and control the delivery of power from the stack to an external load of the fuel cell system. For purposes of establishing communication between the electrical components, the fuel cell system includes a network 10, an embodiment of which is depicted in FIG. 1.

The network 10 includes nodes, or addressable network devices, such as the master node 12 and slave nodes 20 (N slave nodes 20₁, 20₂, . . . 20_{N}, depicted as examples) that are shown in FIG. 1. Each node may be a particular component (an inverter, for example) of the fuel cell system, a group of components (an array of sensors, for example) or a subset of a single component (one out of many possible interfaces to a particular component). The network 10 may be viewed as representing the control subsystem of the fuel cell system.

In some embodiments of the invention, the master node 12, via its communication with the slave nodes 20 over the network 10, controls the overall operation of the fuel cell stack and controls the delivery of power from the fuel cell stack to an external load of the fuel cell system. In some embodiments of the invention, the master node 12 represents the system controller of the fuel cell system; and the slave nodes 12 are formed from the other electrical components (an AC-to-DC inverter, a DC-to-DC converter, sensors, actuators, motors, heaters, relay switches, etc.) of the fuel cell system.

The master node 12 communicates with the slave nodes 20 over a bus 14 that may be a serial bus, in some embodiments of the invention. Additionally, in some embodiments of the invention, the master 12 and slave 20 nodes may communicate over the bus 14 via a packet-based protocol, such as a Controller Area Network (CAN) protocol (as an example) that was developed by Bosch. Thus, in the description herein, references to communications over the bus 14, such as announcements, signals and acknowledgments (as examples), refer to packet-based communications, in some embodiments of the invention.

The slave nodes 20 communicate data with the master node 12 for purposes of allowing the master node 12 to control and monitor operation of the fuel cell system. A given communication from the master node 12 to a particular slave node 20 may be for purposes of requesting an action from the slave node 20, configuring the slave node 20, delivering status information to the slave node 20, etc. A given communication from a particular slave node 20 to the master node 12 may be for purposes of responding to a request from the master node 12, delivering status information gathered by the slave node 20, maintaining a heartbeat signal to indicate non-failure of the slave node 20 (as further described below), etc.

The configuration of the fuel cell system and thus, the components that make up the fuel cell system, specifically depends on the application in which the fuel cell system is used. To increase the flexibility of the system controller so that the controller may be used in a variety of different fuel cell system configurations, the controller is not pre-programmed to implement a specific system configuration. Instead, the controller automatically determines which components have been installed in the fuel cell system and based on the characteristics of these components, configures the system accordingly. This configuration may include the controller selecting one or more control routine(s) from a larger set of control routines based on the identified characteristics for purposes of optimizing performance of the fuel cell system.

Thus, in accordance with some embodiments of the invention, the master node 12 (representing the system controller), upon initial startup of the fuel cell system, identifies the slave nodes 20 that are present in the network 10 (and thus, identifies electrical components of the fuel cell system), obtains characteristics of the recognized slave nodes 20 and then takes actions to tailor control of the fuel cell system based on the characteristics. It is noted that the identification of a particular slave node 20 may be concurrent with obtaining a characteristic of the slave node 20. For example, a unique identification number (ID) of a particular slave node 20 may identify the node 20 as a 5 kW inverter, thereby identifying both the node 20 and a characteristic of the node 20.

Thus, the fuel cell system contains a “plug and play” architecture, an architecture that increases the flexibility of the control subsystem of the fuel cell system and potentially reduces manufacturing time and manufacturing costs.

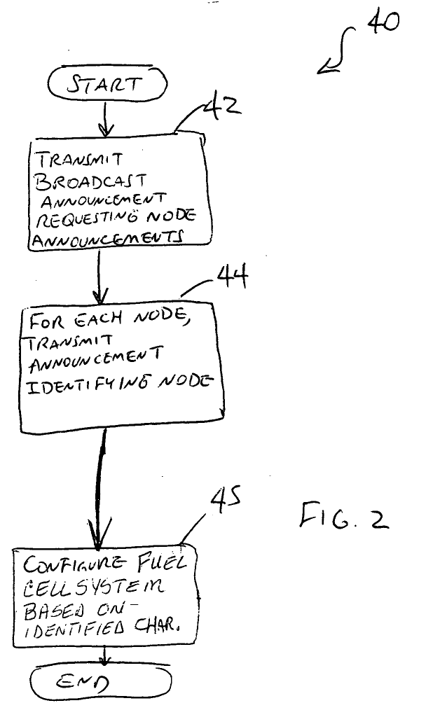

In some embodiments of the invention, the fuel cell system may use a technique 40 that is depicted in FIG. 2 for purposes of automatically configuring the system to the specific installed components. Pursuant to the technique 40, the fuel cell system performs the following functions during the initial startup of the fuel cell system. First, the master node 12 transmits (block 42) a broadcast announcement over the bus 14 requesting node announcements. In other words, at startup, the master node 12 may, for example, transmit a broadcast announcement that requests each of the slave nodes 20 to identify itself. This permits maximum flexibility, in that a “plug and play” system may be implemented in the fuel cell system so that a given component may be plugged into the fuel cell system for a particular configuration, without any previous knowledge of this installation by the system controller.

For example, in a particular 5 kW fuel cell system, a first type of DC-to-DC converter may plugged into the fuel cell system; and for another 10 kW fuel cell system, for example, another type of DC-to-DC converter may be plugged into the system in place of the first type of DC-to-DC converter. The master node 12 recognizes the specific converter via the corresponding slave node's response to the broadcast announcement.

More specifically, in some embodiments of the invention, in response to the broadcast announcement, each slave node 20 transmits (block 44) an announcement that identifies the node 20. The announcement may identify a particular identification number (ID) of the node as well as identify additional information associated with the node, depending on the particular embodiment of the invention. Thus, the announcement from the slave node 20 identifies the presence of and at least one characteristic of the node. In response to the node announcements, the master node 12 configures (block 45) the fuel cell system based on the identified characteristics of the system.

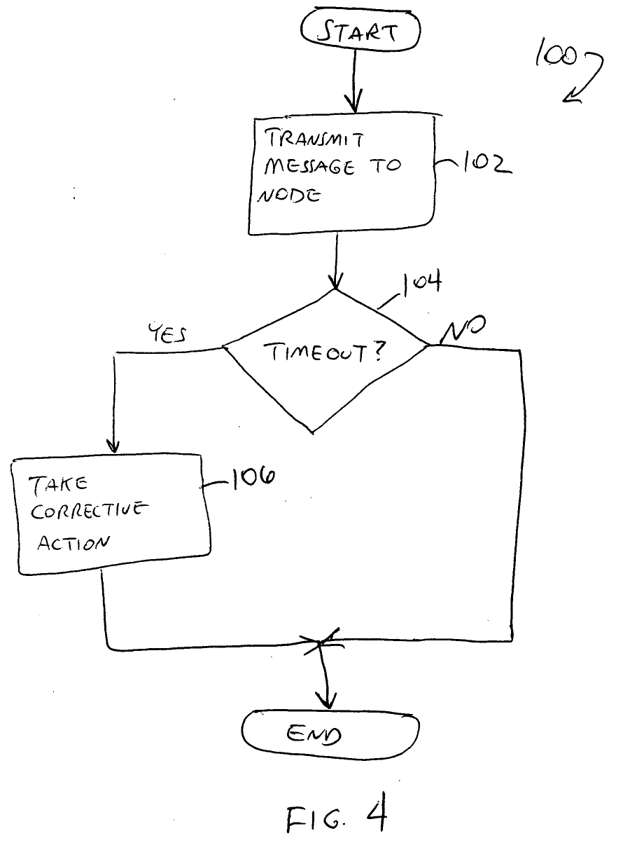

FIG. 3 depicts a message flow diagram 49 that illustrates a more specific example, according to an embodiment of the invention. In the message flow diagram 49, a master node 12 communicates with slave nodes 20₁ and 20₂. At initial power up, the master node 12 transmits a broadcast announcement over the bus 14. In response to the broadcast announcement, the slave node 20₁ transmits a node announcement (at 54) that is received by the master node 12. The master node 12 then transmits an acknowledgement (at 58) back to the slave node 20₁, acknowledging receipt of the node announcement 54 from the slave node 20₁ and thus giving slave node 20₁, permission to begin responding to non-announcement messages and executing its functional behavior. Thus, in response to the node announcement from the slave node 20₁, the master node 12 knows the identity and at least one characteristic of the slave node 20₁.

Similarly, in response to the broadcast announcement, the slave node 20₂ transmits (at 66) a node announcement that is received by the master node 12. The master node 12 acknowledges (at 68) this node announcement, and this acknowledgement is received by the slave node 20₂.

Referring to FIG. 4, in some embodiments of the invention, the fuel cell system may perform a technique 100 for purposes of detecting failure of one of the components of the fuel cell system. Pursuant to the technique 100, the master node 12 monitors messages that are transmitted (block 102) to a particular slave node 20.

The monitored messages may be specific messages to test the response of a slave node 20, or, alternatively, in some embodiments of the invention, the master node 12 may monitor all messages transmitted to a particular slave node 20. Regardless of the particular transmission that is monitored, upon transmission of the message, the master node 12 initializes a timeout counter to determine if the targeted node 20 responds within a specified time.

Thus, pursuant to the technique 100, if the master node 12 determines (diamond 104) that the targeted slave node 20 has not responded within a predetermined time, the master node 12 takes corrective action, as depicted in block 106. The corrective action may include, for example, posting an error message in a memory of the fuel cell system to indicate lost communication with the particular node. Depending on the particular node to which communication is lost, the fuel cell system may be shut down, a redundant subsystem may be activated, a service call may be initiated, etc.

Referring back to FIG. 3, as a more specific example, in some embodiments of the invention, the master node 12 may create a software object (at 59) to monitor transmission of messages to each of the slave nodes 20. Thus, this object may monitor a particular message 60 that is transmitted to the slave node 20₁, for example. If the slave node 20₁ does not respond to receiving the message (at 62) within a specified time, then the object takes corrective action in accordance with the technique 100.

It is noted that not all of the slave nodes 20 may be monitored in the above-identified manner to detect potential failure. For example, as depicted in FIG. 3, the master node 12 creates the object (at 59) to monitor messages (pursuant to the technique 100) with the slave node 20₁. However, as depicted in FIG. 3, the master node 12 does not create such an object to monitor the response of the slave node 20₂ to messages.

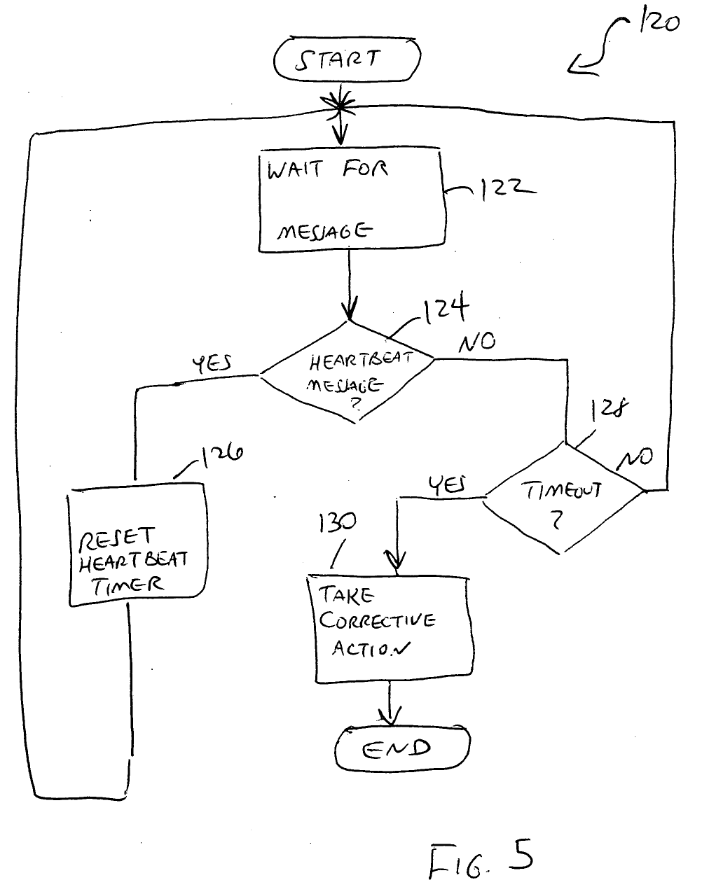

In accordance with some embodiments of the invention, the master node 12 may use other techniques to the detect potential failure of a node, such as the slave node 20₂. For example, referring to FIGS. 3 and 5, in some embodiments of the invention, the control network 10 may use a technique 120 to detect potential failure of a slave node 20. The technique 120 includes the monitoring of heartbeat signals from a particular node to determine if the node 20 has failed. More specifically, in some embodiments of the invention, once a particular slave node 20 is initialized, the slave node 20 is then required to transmit heartbeat signals, (i.e., predefined packets) to the master node 12 at regular intervals. If the master node 12 misses one of these heartbeat signals, then the master node 12 assumes failure of the slave node 20 and takes the appropriate corrective action.

More particularly, in accordance with the technique 120, the master node 12 waits (block 122 of FIG. 5) for a particular message from such a slave node 20. Upon receipt of the message, the master node 12 determines (diamond 124) whether the message is a heartbeat message. If so, then the master node 12 resets (block 126) a heartbeat time counter that tracks the duration between heartbeat messages. If the message is not a heartbeat message, the master node 12 reads the value from the heartbeat time to determine (diamond 128) whether a timeout has occurred. If not, then the master node 12 returns to block 22. Otherwise, a timeout has occurred; and the master node 12 takes corrective action, as depicted in block 130.

As a more specific example, FIG. 3 depicts a scenario in which the master node 12 monitors heartbeat messages from the slave 20₂. It is noted that in this example, the master node 12 does not monitor heartbeat messages from the slave node 20₁. The slave node 20₂ creates an object (at 73) that sends heartbeat messages (at 72) at regular intervals to the master node 12. If the master node 12 fails to receive one of these heartbeat messages (at 74), then the master node 12 takes corrective action and assumes that the slave node 20₂ has failed.

In some embodiments of the invention, the network 10 may be an event-driven communication system. In other words, the master node 12 may not continuously poll each of the slave nodes 20 to determine when a particular event has occurred. Rather, a particular event, such as a timer and/or value change, may trigger a communication action by one of the nodes 12 and 20.

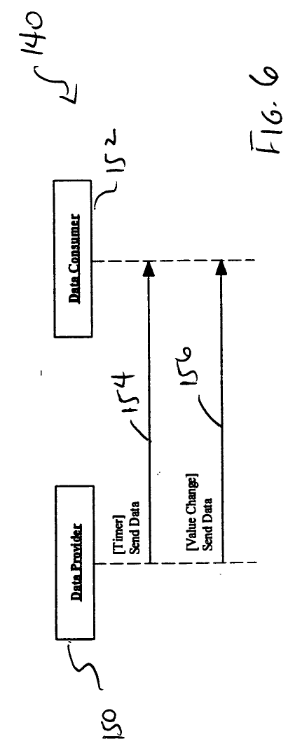

As a more specific example, FIG. 6 depicts a block diagram 140 showing an exchange between a data provider 150 and a data consumer 152 of the network 10. The provider 150 may be either the master node 12 or one of the slave nodes 20; and likewise, the data consumer 152 may be the master node 12 or one of the slave nodes 20. In this example, depicted in FIG. 6, the data provider 150 transmits a message (at 154) to the data consumer 152 in response to a timer change. For example, the data provider 150 may include a timer that, on expiration, triggers an interrupt that causes the data provider 150 to send a packet of data to the data consumer 152.

As another example, the data provider 150 may monitor particular data to determine a change in the data and transmit a message packet (at 156) to the data consumer 152 in response to this detected change. As a more specific example, the data provider 150 may be, for example, a sensor that monitors a particular value. When this value falls outside of a predefined range, the sensor then transmits the data to the controller. Other variations are possible in other embodiments of the invention.

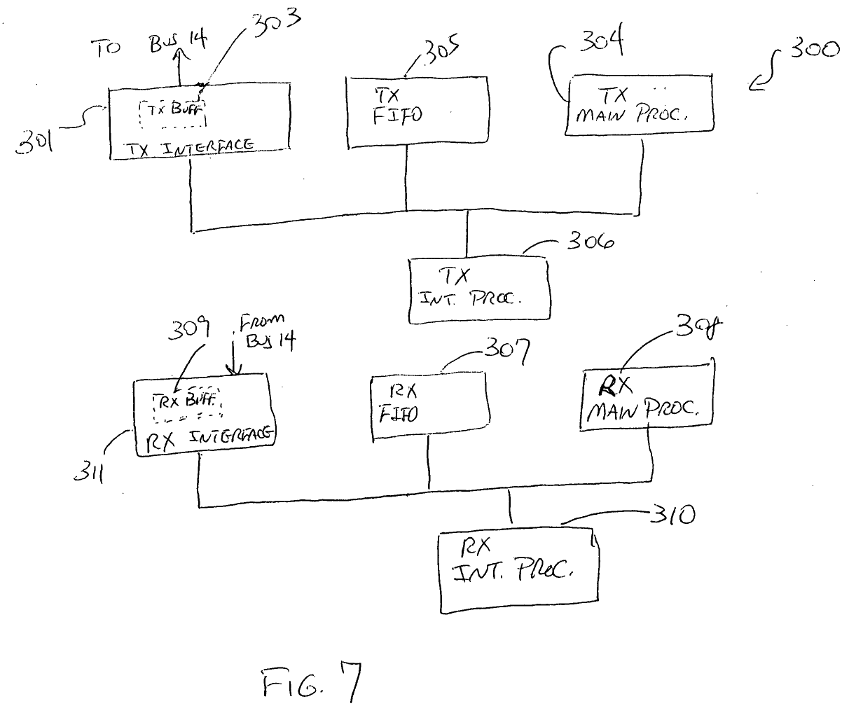

For purposes of implementing this event-driven communication system, each node 12, 20 may have an architecture 300 that is depicted in FIG. 7. Referring to FIG. 7, this architecture 300 includes a transmit main processor 304 that processes data to be communicated over the network to a transmit buffer 303 of a transmit interface 301 and initializes the interface 301 for the transmission. The architecture 300 also includes a secondary transmit processor 306 that controls the transfer of data to be transmitted from a first-in-first-out (FIFO) 305 into the transmit buffer 303. In some embodiments of the invention, each of the processors 304 and 306 may be software objects, such as objects created by a C++ object-oriented programming language, for example. Alternatively, the processors 304 and 306 may be implemented in hardware.

For purposes of processing data received from the network 10, the architecture 300 may include a receive main processor 308, a processor that processes data that is present in a receive FIFO 307. The architecture 300 may include a secondary receive processor 310 that transfers data between a receive button 309 (of the receive interface 311) and the receive FIFO 307. The processors 308 and 310 may each be implemented as a software object or in hardware, depending on the particular embodiment of the invention.

FIG. 8 depicts a flow diagram 320 illustrating actions by the receive main processor 308 according to an embodiment of the invention. The actions by the processor 308 are initiated in response to a receive interrupt occurring in response to received data. Thus, pursuant to the technique 320, the first action by the processor 308 is to enable (block 322) another assertion of the receive interrupt. Next, the receive processor 308 determines (diamond 324) whether the receive FIFO 307 is not empty. If so, then the receive processor 308 retrieves (block 326) a packet from the receive FIFO 307, decrements (block 328) a receive FIFO counter and then processes (block 330) the packet. Control then returns to diamond 324 until the receive FIFO 307 is empty.

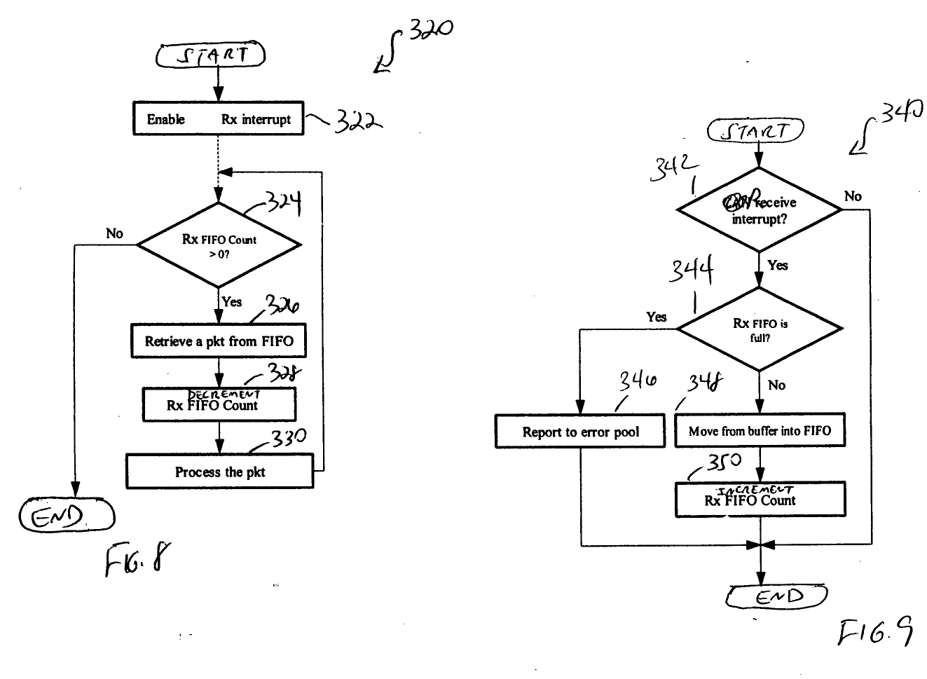

FIG. 9 depicts a flow diagram 340 depicting the transfer of data from the buffer 309 into the FIFO 307, according to an embodiment of the invention. If the secondary receive processor 310 determines (block 342) that a receive interrupt has been received, then the receive interrupt processor 310 determines (diamond 344) whether the receive FIFO 307 is full. If so, then the receiver processor 308 reports (block 346) an error. Otherwise, the processor 310 moves data from the buffer 309 into the receive FIFO 307 so that the receive main processor 308 may process this data, as depicted in block 348. Subsequently, the receive processor 310 increments the receive FIFO counter, as depicted in block 350.

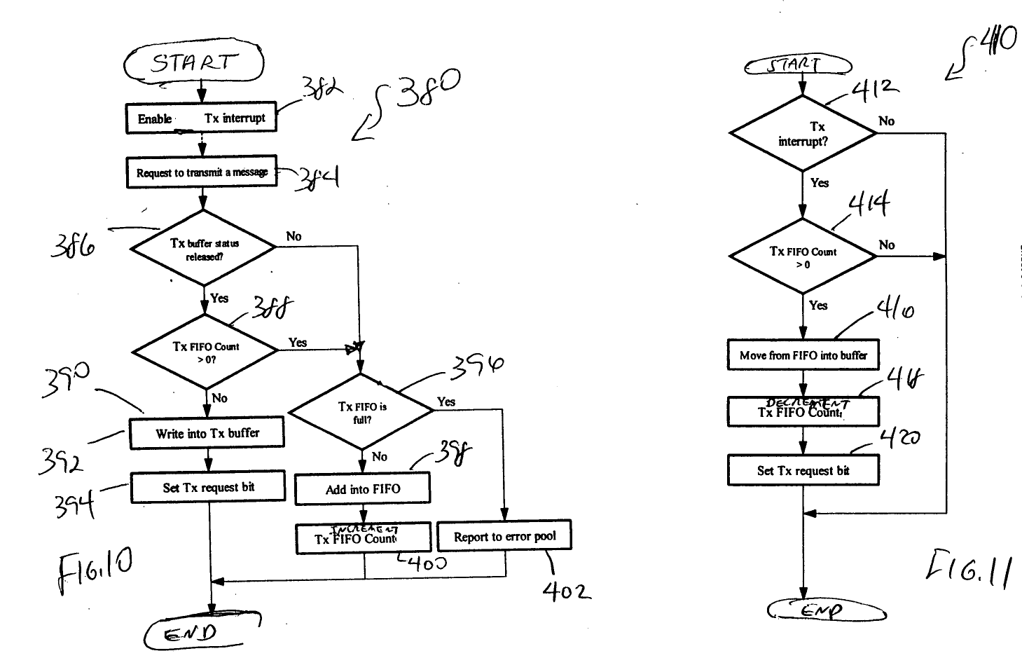

FIG. 10 depicts a technique 380 illustrating actions by the transmit main processor 304 in accordance with some embodiments of the invention. Pursuant to the technique 380, the transmit main processor 304 first enables (block 382) the transmit interrupt and then makes a request (384) to the transmit interface 301 to transmit a message over the network 10. If the transmit main processor 304 determines (block 386) that the transmit buffer status is released (indicating the data may be transmitted), then the transmit main processor 304 determines (diamond 388) if the transmit FIFO 305 is non-empty. If either the transmit FIFO 305 is non-empty or the transmit buffer status has not been released, then control passes to diamond 396 in which the transmit main processor 304 determines if the transmit FIFO 305 is full. If so, then the transmit main processor 304 reports an error, as depicted in block 402. Otherwise, the transmit main processor 304 adds data into the transmit FIFO 305, as depicted in block 398 and then increments (block 400) the transmit FIFO counter. If the transmit main processor 304 determines (block 388) that the transmit FIFO count is empty, then the transmit main processor 304 writes (block 392) into the transmit buffer 303 and subsequently sets (block 394) a transmit request bit.

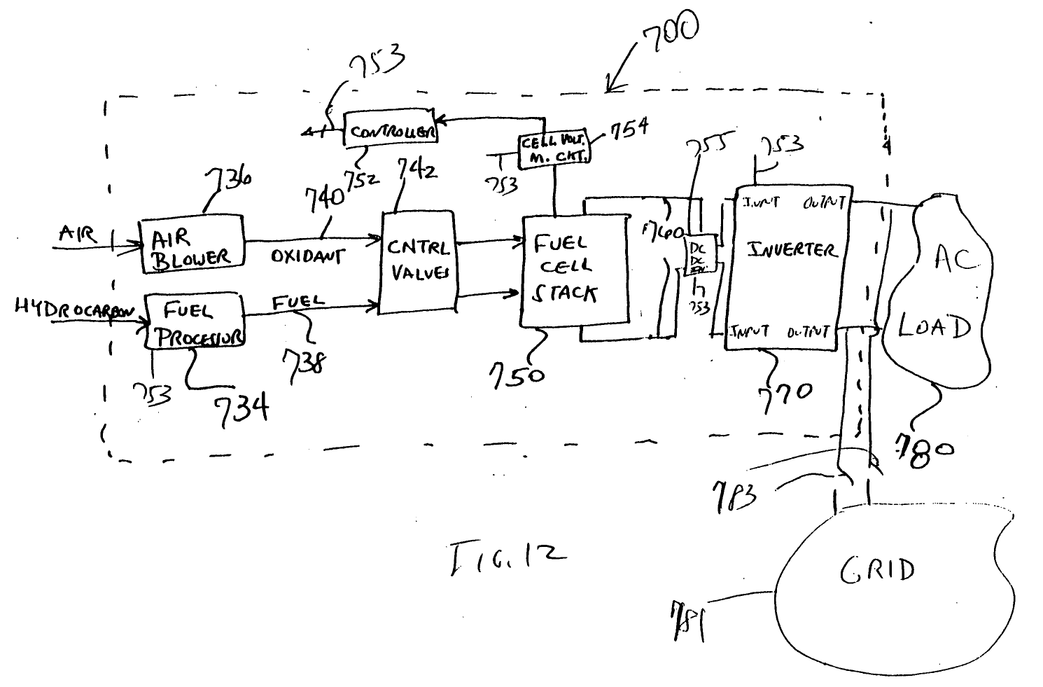

FIG. 11 depicts an exemplary technique 410 that may be used by the secondary transmit processor 306 in accordance with some embodiments in the invention. Pursuant to the technique 410, the processor 306 determines (diamond 412) whether a transmit interrupt has occurred. If so, the transmit interrupt processor 306 determines (block 414) whether the transmit FIFO counter is non-empty. If so, then the processor 306 moves data from the transmit FIFO 305 into the buffer 303, as depicted in block 416; and then, the processor 306 decrements the transmit FIFO counter, as depicted in block 418. Subsequently, the processor 306 sets the transmit request bit in the transmit interface 301, as depicted in block 420.

FIG. 12 depicts an exemplary fuel cell system 700 in accordance with some embodiments of the invention. The fuel cell system 700 includes a fuel cell stack 750 (a PEM-type fuel cell stack, for example) that is capable of producing power that is used to power an AC power consuming, external load 780 (as an example). The power that is produced by the fuel cell stack 750 is in response to fuel and oxidant flows that are provided by a fuel processor 734 and an air blower 736, respectively. More specifically, the fuel cell system 700 controls the fuel production of the fuel processor 734 (i.e., controls the rate at which the fuel processor 734 provides reformate) to control the fuel flow that is available for electrochemical reactions inside the fuel cell stack 750. Control valves 742 of the fuel cell system 700 generally route most of the fuel flow to the stack 750, with the remainder of the fuel flow being diverted to a flare, or oxidizer (not depicted in FIG. 12).

The fuel cell stack 750 includes output terminals that provide a DC voltage to a fuel cell bus 760. This fuel cell bus 760, in turn, connects the terminals of the fuel cell stack 750 to input terminals of an inverter 770. The inverter 770, in response to the DC input power that is provided from the fuel cell stack 750, produces AC power for the load 780.

In some embodiments of the invention, the fuel cell system 700 may provide power to a power grid 781 when switches 783 (provided by the contacts of a relay, for example) are closed to connect the output terminals of the inverter 770 to the power grid 781. Additionally, in some embodiments of the invention, the fuel cell system 700 may close the switches 783 for purposes of receiving power from the grid 781. More particularly, the fuel cell system 700 may close the switches 783 to receive power from the grid 781 during the startup of the system 700, in some embodiments of the invention.

Among its other features, the fuel cell system 700 may include a DC-to-DC converter 755 that is connected to the fuel cell bus 760 for purposes of converting a DC voltage level from the bus 760 into another DC level for the inverter 770. The fuel cell system 700 may also include a cell voltage monitoring circuit 754 that, in some embodiments of the invention, scans the cell voltages of the fuel cell stack 750 for purposes of monitoring the performance and condition of the fuel cells of the fuel cell stack 750. The cell voltage monitoring circuit 754 may communicate the scanned cell voltages to a system controller 752. The controller 752 controls the fuel processor 734, inverter 770 and other components of the fuel cell system 700 via its network connection to these components by a serial bus 753. The serial bus 753 also permits the controller 752 to receive status information from the circuit 754 and various sensors, monitor and recognize the various nodes of the fuel cell system, and thus, establish a network 10 (FIG. 1) to control the fuel cell system 700, as discussed above.

Other embodiments are within the scope of the following claims. For example, in some embodiments of the invention, some components of the fuel cell system, such as the inverter 770 (as an example), may be coupled to a CAN bus, instead of the serial bus 753.

The fuel cell system 700 may have various other components and subsystems that are not depicted in FIG. 12. For example, the fuel cell system 700, in some embodiments of the invention, may have a coolant subsystem for purposes of regulating a temperature of the fuel cell stack, may include various switches and/or relays for purposes of emergency disconnection purposes, may include an exhaust recirculation subsystem, etc.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method comprising:
providing a network in communication with components of a fuel cell system;
identifying at least one node of the network; and
automatically configuring the fuel cell system based on at least one characteristic of said at least one node.

2. The method of claim 1, wherein the identifying comprises:
transmitting a broadcast message at power-up of the fuel cell system requesting a response from said at least one node.

3. The method of claim 2, further comprising:
transmitting a node announcement in response to the broadcast message.

4. The method of claim 1, wherein the automatically configuring comprises:
selecting a control routine based on said at least one characteristic.

5. A fuel cell system comprising:
a component of the fuel cell system; and
a circuit to identify said at least one component and automatically configure the fuel cell system based on at least one characteristic of the identified component.

6. The fuel cell system of claim 5, wherein the circuit is adapted to transmit a broadcast message requesting said at least one component to identify itself to the circuit at power-up of the fuel cell system.

7. The fuel cell system of claim 6, wherein said at least one component is adapted to transmit an announcement identifying said at least one component to the circuit in response to the broadcast message.

8. The fuel cell system of claim 1, wherein the circuit is adapted to select a control routine in response to said at least one characteristic.

9. A method comprising:
monitoring a message communicated to a node in a fuel cell system; and
taking corrective action to a response of the node to the message.

10. The method of claim 9, further comprising:
taking corrective action in response to the node not responding to the message in a predefined time.

11. The method of claim 9, wherein the message comprises a message designated to determine whether the node is responding.

12. The method of claim 9, wherein the corrective action comprises at least one of a shutdown of the fuel cell system, an activation of a redundant system and a post of an error status.

13. The method of claim 9, wherein the corrective action comprises an assumption that the node has failed.

14. A fuel cell system comprising:
a node in a fuel cell system; and
a circuit to monitor a message communicated to the node and take corrective action in a response to a response of the node to the message.

15. The fuel cell system of claim 14, wherein the circuit takes corrective action in response to the node not responding to the message within a predefined time.

16. The fuel cell system of claim 14, wherein the message comprises a message designated to determine whether the node is responding.

17. The fuel cell system of claim 14, wherein the corrective action comprises at least one of a shutdown of the fuel cell system, an activation of a redundant system and a post of an error status.

18. The fuel cell system of claim 14, wherein the corrective action comprises an assumption that the node has failed.

19. A method comprising:
taking corrective action in response to a node in a fuel cell system not providing a signal according to a predefined transmission schedule.

20. The method of claim 19, wherein the signal comprises a message packet communicated over a bus.

21. The method of claim 19, wherein the corrective action comprises at least one of a shutdown of the fuel cell system, an activation of a redundant system and a post of an error status.

22. The method of claim 19, wherein the corrective action comprises an assumption that the node has failed.

23. The method of claim 19, wherein the predefined transmission schedule comprises transmission of the signal at regular intervals.

24. A fuel cell system comprising:
a node of a fuel cell system; and
a circuit to take corrective action in response to the node not providing a signal according to a predefined transmission schedule.

25. The fuel cell system of claim 24, wherein the signal comprises a message communicated over a network of the fuel cell system.

26. The fuel cell system of claim 24, wherein the corrective action comprises at least one of a shutdown of the fuel cell system, an activation of a redundant system and a post of an error status.

27. The fuel cell system of claim 24, wherein the corrective action comprises an assumption that the node has failed.

28. The fuel cell system of claim 24, wherein the predefined transmission schedule comprises transmission of a signal at regular intervals.
